(19) United States
(12) Patent Application Publication
(10) Pub. No.: US 2026/0163969 A1
(43) Pub. Date: Jun. 11, 2026

(54) VEHICLE CONTROL SYSTEM AND METHOD

(71) Applicants: HYUNDAI MOTOR COMPANY, SEOUL (KR); KIA CORPORATION, SEOUL (KR)

(72) Inventors: Hang Hang Wang, Yantai (CN); Kyong Ho Shon, Hwaseong-si (KR); Jin Shun Li, Yantai (CN); Xi Sha Li, Yantai (CN); In Sik Chun, Hwaseong-si (KR); Hui Xie, Yantai (CN)

(73) Assignees: HYUNDAI MOTOR COMPANY, SEOUL (KR); KIA CORPORATION, SEOUL (KR)

(21) Appl. No.: 18/977,326

(22) Filed: Dec. 11, 2024

(30) Foreign Application Priority Data
Dec. 6, 2024 (CN) 202411793133.9

(51) Int. Cl. H04M 1/60; H04B 17/318; H04W 4/02; H04W 4/40; H04W 4/80; H04W 12/50

(52) U.S. Cl. CPC H04M 1/6091; H04B 17/318; H04W 4/025; H04W 4/40; H04W 4/80; H04W 12/50

(57) ABSTRACT

A vehicle control system includes a communication device configured to perform pairing between a user terminal and a vehicle using a Bluetooth® signal to perform the transmission and reception of an audio signal, a first processing unit configured to determine a relative position of the user terminal with respect to the vehicle, and a second processing unit configured to set a call channel of the user terminal using a call connection system of the vehicle when it is determined that the user terminal is positioned inside the vehicle using the relative position, and set the call channel using the user terminal when it is determined that the user terminal is positioned outside the vehicle.

### CROSS REFERENCE TO RELATED APPLICATIONS

This application claims the benefit of priority to Chinese Patent Application No. 202411793133.9 filed Dec. 6, 2024, the disclosure of which is herein incorporated by reference in its entirety.

### TECHNICAL FIELD

Embodiments relate to a vehicle control system and method.

### BACKGROUND

Hands-free calling using Bluetooth® satisfies customers'needs for calls while driving and contributes to safe driving of vehicles. However, depending on a Bluetooth® connection distance, there are cases in which internal speakers and microphone of the vehicle are set to a default call device even when making a call outside the vehicle, making it difficult to make normal calls.

### SUMMARY

Any portable phone positioning technology is being applied to vehicles, and embodiments are directed to providing a vehicle control system and method, which automatically set input and output devices for performing calls depending on a position of a portable phone in conjunction with such a positioning technology.

An audio video navigation telematics (AVNT) solves the above problem by performing automatic switching of a Bluetooth® call channel when detecting a portable phone positioned outside a vehicle. The automated switching can increase use convenience of a user and increase user satisfaction.

According to an embodiment, there is provided a vehicle control system including a communication device configured to perform pairing between a user terminal and a vehicle using a Bluetooth® signal to perform the transmission and reception of an audio signal, a first processing unit configured to determine a relative position of the user terminal with respect to the vehicle, and a second processing unit configured to set a call channel of the user terminal using a call connection system of the vehicle when it is determined that the user terminal is positioned inside the vehicle using the relative position, and set the call channel using the user terminal when it is determined that the user terminal is positioned outside the vehicle.

The first processing unit may determine the relative position at regular intervals while the user terminal is busy.

When it is determined that the user terminal is moved from the inside of the vehicle to the outside of the vehicle while the user terminal is busy, the second processing unit may switch the call channel from the call connection system to the user terminal.

When it is determined that the user terminal is moved from the outside of the vehicle to the inside of the vehicle while the user terminal is busy, the second processing unit may switch the call channel from the user terminal to the call connection system.

The second processing unit may set the call channel according to a signal received through the call connection system.

The second processing unit may receive and output an audio signal of content reproduced in the user terminal using the set call channel.

The first processing unit may determine the relative position using a positioning result through at least one of Wi-Fi, digital key Bluetooth® low energy (BLE), ultra-wideband (UWB) methods.

The first processing unit may determine the relative position using an opening/closing state of a door of the vehicle and a strength of the Bluetooth® signal.

The second processing unit may determine whether the user terminal is positioned inside or outside the vehicle using the positioning result, a sit-down detection signal of a seat sensor, and a belt fastening signal of a seat belt sensor.

The second processing unit may display a currently set call channel using the call connection system.

According to an embodiment, there is provided a vehicle control method including performing, by a communication device, pairing between a user terminal and a vehicle using a Bluetooth® signal, determining, by a processor, a relative position of the user terminal with respect to the vehicle, and setting, by the processor, a call channel of the user terminal using a call connection system of the vehicle when it is determined that the user terminal is positioned inside the vehicle using the relative position, and setting the call channel using the user terminal when it is determined that the user terminal is positioned outside the vehicle.

The determining of the relative position may include determining a call state of the user terminal, and determining the relative position at regular intervals while the user terminal is busy.

The setting of the call channel may include switching the call channel from the call connection system to the user terminal when it is determined that the user terminal is moved from the inside of the vehicle to the outside of the vehicle while the user terminal is busy.

The setting of the call channel may include switching the call channel from the user terminal to the call connection system when it is determined that the user terminal is moved from the outside of the vehicle to the inside of the vehicle while the user terminal is busy.

The vehicle control method may further include setting, by the processor, the call channel according to a signal received through the call connection system.

The vehicle control method may further include stopping, by the processor, an operation of determining the relative position.

The vehicle control method may further include receiving and outputting, by the processor, an audio signal of content reproduced in the user terminal using the set call channel.

The first processing unit may determine the relative position using an opening/closing state of a door of the vehicle and a strength of the Bluetooth® signal.

The determining of the relative position may include performing positioning through at least one of Wi-Fi, digital key Bluetooth® low energy (BLE), and ultra-wideband (UWB) methods, and determining whether the user terminal is positioned inside or outside the vehicle using a positioning result, a sit-down detection signal of a seat sensor, and a belt fastening signal of a seat belt sensor.

The vehicle control method may further include displaying, by the processor, a currently set call channel using the call connection system.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a view for describing a vehicle according to an embodiment;

FIG. 2 is a block diagram illustrating a configuration of a user terminal according to the embodiment;

FIG. 3 is a conceptual diagram of a vehicle control system according to the embodiment;

FIG. 4 is a block diagram illustrating a configuration of the vehicle control system according to the embodiment; and

FIGS. 5, 6, 7, 8, 9, 10, 11, and 12 are views for describing operations of the vehicle control system according to the embodiment.

### DETAILED DESCRIPTION

Hereinafter, exemplary embodiments of the present disclosure will be described in detail with reference to the accompanying drawings.

However, the technical spirit of the present disclosure is not limited to some of the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are only for the purpose of distinguishing one component from another component, and the nature, sequence, order, etc. of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof will be omitted.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

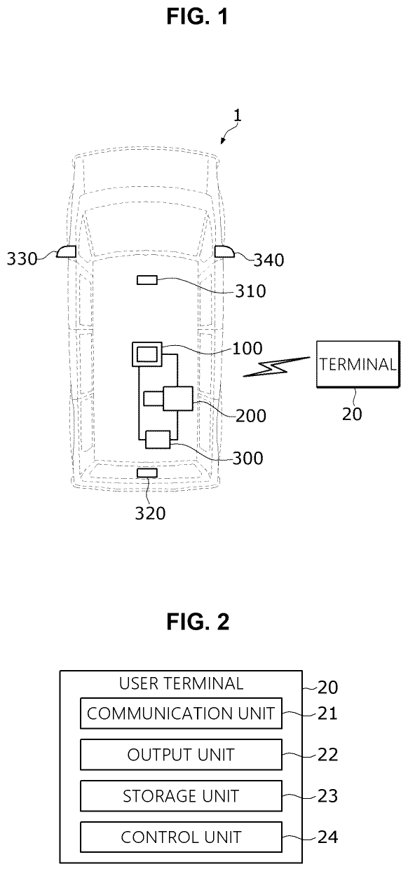

FIG. 1 is a view for describing a vehicle according to an embodiment. Referring to FIG. 1, a vehicle 1 may include an audio video navigation telematics (AVNT) 100 provided in a center fascia to control an audio device, an air conditioner, a Bluetooth® device, a seat heater, etc.

An input device for receiving a user input may be disposed on the center fascia or the AVNT 100, and a display device for displaying operation information for at least one of functions performed in the vehicle 1 may also be disposed.

The input device may include hardware devices such as various buttons or switches, pedals, a keyboard, a mouse, a track-ball, various levers, a handle, a stick, etc.

In addition, the input device may include a graphical user interface (GUI), that is, a software device, such as a touch pad. The touch pad may be implemented as a touch screen panel (TSP) to form a mutual layer structure with a display panel of the display device.

The display device may function as a user interface. The display device may display the vehicle's operating state, control state, route/traffic information, energy remaining information, content requested by a driver, etc., by a processor. In addition, the display device may be formed as a touch screen capable of detecting a driver input to receive the driver's request that instructs the processor.

The internal part of a vehicle body may include a keyway into which a fob type or card type remote controller may be inserted. Here, the keyway may be provided in a dashboard or center fascia and provided at a position adjacent to a driver's seat.

The vehicle 1 may transmit and receive information with a remote controller or a terminal when the remote controller is inserted into the keyway or when authentication with the remote controller or terminal is completed via a wireless communication network.

The internal part of the vehicle body may further include a start button that receives turn-on/off commands. Therefore, the vehicle starts when the start button is pressed by the user after the authentication with the remote controller or terminal is completed.

The vehicle 1 may further include a communication device for transmitting and receiving information with at least one of electronic devices and a user terminal 20 that are provided in the vehicle.

A communication device 300 may include one or more components that enable communication between in-vehicle components and, for example, may include at least one of a short-range communication module, a wired communication module, and a wireless communication module.

For example, the short-range communication module may include various short-range communication modules for transmitting and receiving signals using a wireless communication network at a short distance, such as a Bluetooth® module, an infrared communication module, a radio frequency (RF) identification communication module, a wireless local access network (WLAN) communication module, a near-field communication (NFC) communication module, a ZigBee communication module, etc.

For example, the wired communication module may include not only various wired communication modules such as a controller area network (CAN) communication module, a local area network (LAN) module, a wide area network (WAN) module, a value added network (VAN) module, etc., but also various cable communication modules such as a universal serial bus (USB), a high definition multimedia interface (HDMI), a digital visual interface (DVI), a recommended standard 232 (RS-232), power line communication, plain old telephone service (POTS), etc.

For example, a controller area network (CAN) may comprise a communication protocol designed for real-time data exchange between microcontrollers and devices within vehicles and industrial systems. CAN may allow multiple electronic control units to communicate with each other without the need for a host computer, making it useful for applications where reliable, high-speed communication is critical.

For example, a value added network (VAN) may comprise a private network that may provide businesses with secure, reliable communication channels for exchanging data and documents. VANs may offer services (e.g., data encryption, format translation, message routing, or tracking, etc.) to ensure that business documents (e.g., invoices, purchase orders, or shipping notices, etc.) may be transmitted efficiently and/or securely between trading partners. The wired communication module may further include a local interconnect network (LIN). For example, a local interconnect network (LIN) may comprise a low-cost serial communication protocol that may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

In addition, in addition to the Wi-Fi module and the wireless broadband (WiBro) module, the wireless communication module may include a wireless communication module for supporting various wireless communication methods, such as global system for mobile communication (GSM), code division multiple access (CDMA), wideband code division multiple access (WCDMA), universal mobile telecommunications system (UMTS), time division multiple access (TDMA), long term evolution (LTE), etc.

A user terminal 20 communicates with the vehicle 1, receives at least one of vehicle door lock and unlock commands, tailgate lock and unlock commands, a start command, a lamp lighting command, and a start command as a user input, and transmits information corresponding to the received command to the vehicle. The user terminal 20 may transmit a communication signal for the information corresponding to the received command to the vehicle.

The user terminal 20 may be implemented as a computer or portable terminal that can be communicatively connected to the vehicle via a network.

Here, the computer may include, for example, a notebook, a desktop, a laptop, a tablet PC, a slate PC, etc., that are provided with a WEB browser, and the portable terminal is a wireless communication device that ensures portability and mobility and may include, for example, any kind of handheld-based wireless communication device such as a personal communication system (PCS), a GSM, a personal digital cellular (PDC), a personal handyphone system (PHS), a personal digital assistant (PDA), an international mobile telecommunication (IMT)-2000, CDMA-2000, WCDMA, and wireless broadband Internet (WiBro) terminals, a smartphone, etc., and wearable devices such as a watch, a ring, a bracelet, an anklet, a necklace, glasses, contact lenses, a head-mounted-device (HMD), etc.

In an embodiment, the user terminal 20 may communicate with the vehicle through a Bluetooth® low energy (BLE) communication method. The user terminal 20 may perform communication based on the Bluetooth® beacon standard (iBeacon).

The AVNT 100 means an information and entertainment system in a vehicle and may be a system that integrates navigation, audio, video, and communication functions. The AVNT 100 may output a message generated by a processor 200 in at least one of a visual manner, an audible manner, and a combination thereof.

The AVNT 100, the processor 200, and the communication device 300 may be implemented as one module, but in the embodiment, will be described separately for convenience of description.

The AVNT 100 may be a component for providing a hardware interface integrated into the system in the vehicle. The AVNT 100 may perform system control for a screen, buttons, and various integrated information and entertainment functions.

The AVNT 100 may be installed at the center or console of the vehicle dashboard to provide vehicle information and an entertainment interface. The information and entertainment system may include AM/FM radio, satellite radio, DVDs/CDs, cassette tapes, USB MP3, dashcams, GPS navigation devices, Bluetooth®, Wi-Fi, etc., and may provide the state information of the vehicle system. In addition, the AVNT 100 may perform functions such as voice control and motion recognition.

The processor 200 may control the vehicle body such as a vehicle, doors, windows, or keys (a digital key, a smartphone key, and a fob). The processor may perform a body control function (BCM), a smart key entry/start function (SMK), a tire air pressure monitoring function (TPMS), an immobilizer function (IMMO), digital key authentication (IAU), an autonomous parking related control function (PDW), etc. For example, the processor 200 may be a body domain controller (BDC), but is not limited thereto, and may be used to encompass a platform controller for providing electronic convenience functions to a body domain area.

FIG. 2 is a block diagram illustrating a configuration of a user terminal according to the embodiment. Referring to FIG. 2, the user terminal 20 may include a communication unit 21, an output unit 22, a storage unit 23, and a control unit 24.

The user terminal 20 may include a smartphone, a smart pad, a notebook computer, etc. that the user can carry. The user terminal 20 may store a digital key that generates authentication information for controlling functions such as locking and unlocking of the vehicle door, remote starting, emergency alarm, and trunk opening.

The communication unit 21 may include a transceiver for transmitting and receiving information using an antenna, a communication circuit, a communication processor, etc., and perform short-range communication with the vehicle. According to an embodiment, the communication unit 21 may perform NFC communication or ultra-wideband (UWB) communication.

The output unit 22 may output information stored in the user terminal 20 in at least one of a visual manner, an audible manner, and a combination thereof. According to an embodiment, the output unit 22 may be implemented as a display device that adopts a liquid crystal display (LCD) panel, a light emitting diode (LED) panel, an organic light emitting diode (OLED) panel, a plasma display panel (PDP), etc. The LCD may include a thin film transistor LCD (TFT-LCD). The output unit 22 may be implemented by being formed integrally with the input unit (not shown) by a touch screen panel (TSP).

The storage unit 23 may store at least one algorithm that performs calculation or execution of various commands for the operation of the user terminal 20 according to one embodiment of the present disclosure. The storage unit 23 may include at least one storage medium of a flash memory, a hard disc, a memory card, a read-only memory (ROM), a random access memory (RAM), an electrically erasable programmable ROM (EEPROM), a programmable ROM (PROM), a magnetic memory, a magnetic disc, and an optical disc. The storage unit 23 may store driver information for a plurality of vehicles.

The control unit 24 may be implemented by various processing devices such as a microprocessor having a semiconductor chip capable of performing calculations or executions of various commands embedded therein and may control the operation of the user terminal 20 according to one embodiment. The control unit 24 may be electrically connected to the communication unit 21, the output unit 22, and the storage unit 23 through a wired cable or various circuits to transmit electrical signals including control commands and the like and may transmit and receive electrical signals including control commands and the like by various wireless communication networks such as a CAN.

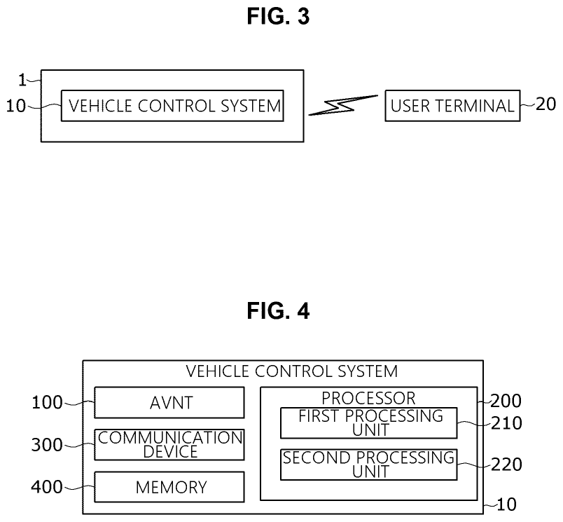

FIG. 3 is a conceptual diagram of a vehicle control system according to the embodiment, and FIG. 4 is a block diagram illustrating a configuration of the vehicle control system according to the embodiment.

Referring to FIGS. 3 and 4, a vehicle control system 10 may include the AVNT 100, the processor 200, the communication device 300, and a memory 400 and perform short-range communication with the user terminal 20.

In the vehicle control system 10 according to the embodiment, the user terminal 20 may operate as a digital key. Hereinafter, the digital key and the user terminal may be used as terms referring to the same component.

The digital key/user terminal 20 may open or close the door provided in the vehicle 1, start or stop the vehicle 1, and execute various functions included in the vehicle 1 as needed. The digital key/user terminal 20 may be a device that may use one or more of low-power Bluetooth® (BLE) communication and NFC.

One digital key/user terminal 20 may be operated by being linked to a specific vehicle 1 and, as needed, a plurality of digital key/user terminals 20 may be linked to one vehicle 1 or one digital key/user terminal 20 may be linked to a plurality of vehicles 1. In addition, there may be a case in which a plurality of digital keys/user terminals 20 are linked to a plurality of vehicles 1.

In addition, the digital key/user terminal 20 may be installed and operated in a device such as a smartphone, and there may be a case in which a plurality of digital key/user terminals 20 are installed in one smartphone. Although the embodiment describes an example in which the digital key/user terminal 20 is installed and operated in the smartphone, the present disclosure is not limited thereto, and as needed, the digital key/user terminal 20 may be installed in a device other than the smartphone.

The digital key/user terminal 20 may control the vehicle 1 and to this end, may communicate with the vehicle 1 through BLE communication, UWB communication, wireless Internet network communication, or mobile communication network communication.

The digital key/user terminal 20 may be manipulated by the user to perform various functions for controlling the vehicle 1 and manipulated to set one or more wireless anchors.

The digital key/user terminal 20 may search for nearby wireless anchors and register the found wireless anchors. That is, the digital key/user terminal 20 may use various communication methods to search for wireless anchors that may be connected to wireless communication. For example, when two wireless anchors are positioned near the digital key/user terminal 20 and one wireless anchor may perform communication in a BLE communication manner and the other may perform communication through wireless Internet network communication, the digital key/user terminal 20 may be communicatively connected to one of the two wireless anchors or communicatively connected to both wireless anchors.

The wireless anchor may be an electronic device capable of performing communication via BLE communication, UWB communication, wireless Internet network communication, or mobile communication network communication. For example, the wireless anchor may be an electronic module mounted on the vehicle 1 to use the communication device such as UWB communication, BLE communication, Wi-Fi AP, or Bluetooth® beacon device.

In an embodiment, the user terminal 20 may perform functions of a hands-free call mode and a phone call mode. For the hands-free call mode, the user terminal 20 may have a short-range communication module for short-range communication with the vehicle 1. The short-range communication module may be a Bluetooth® module. In an embodiment, the user terminal 20 may activate the hands-free call mode or the phone call mode according to a call mode command message transmitted via short-range communication from the communication device of the vehicle 1.

In an embodiment, the hands-free call mode is a mode in which a call channel of the user terminal 20 is set using the AVNT 100 of the vehicle 1 and may be a mode in which at least one of a video signal and an audio signal for making a call or reproducing a digital content is input and output through the AVNT 100 of the vehicle.

In an embodiment, the phone call mode is a mode in which a call channel is set using the user terminal 20 and may be a mode in which at least one of a video signal and an audio signal for making a call or reproducing a digital content is input and output through the user terminal 20.

The communication device 300 may perform pairing between the user terminal 20 and the vehicle 1 using a Bluetooth® signal to transmit and receive the audio signal.

The communication device 300 may include a transceiver for transmitting and receiving information using an antenna, a communication circuit, a communication processor, etc., and perform short-range communication with the user terminal 20. According to an embodiment, the communication device 300 may perform Bluetooth® communication, NFC communication, or UWB communication. The communication device 300 may be provided near a door handle of the vehicle 1 to request authentication information when it is determined that the user terminal approaches within a predetermined distance.

In the hands-free device using the Bluetooth® module, when the vehicle 1 is turned on, the Bluetooth® function is also turned on, and the device enters a connection standby state, and a driver connects the vehicle with his or her portable phone. When the connection is completed, the driver may make a phone call in a Bluetooth® hands-free manner.

In the Bluetooth® standard, Bluetooth® 1.0 stipulates that a data transmission rate is 1 Mbps and a transmission distance ranges from 10 to 100 m, and communication is possible even in the presence of obstacles because Bluetooth® 1.0 uses a high radio frequency of 2.4 GHz.

When the driver who carries a portable phone outside the vehicle 1 manipulates the digital key/user terminal to remotely start the vehicle 1, the communication device 300 according to the embodiment may automatically connect the vehicle 1 to the user terminal 20 under the control of the processor 200 so that the driver boards the vehicle 1 to immediately use the hands-free function.

The communication device 300 may include a plurality of positioning modules 310 to 340. The positioning modules 310 to 340 may be short-range wireless communication modules, and each wireless communication module may measure the strength of a wireless signal received from the user terminal. One of the plurality of wireless communication modules mounted on the vehicle 1 may be set to a master module. The master module may collect and transmit the strength of a wireless signal measured by another wireless communication module to the processor.

For example, the positioning modules 310 to 340 may be composed of a Bluetooth® module, a BLE module, a Wi-Fi module, etc. The positioning modules 310 to 340 may be provided at a front portion, a rear portion, a left side, and a right side of the vehicle 1 and may independently measure and transmit the strength of the wireless signal of the user terminal 20 to the master module.

The processor 200 may perform the overall control of the vehicle 1. The processor 200 may be configured to execute applications and instructions that are stored in the memory 400. The processor 200 may include a first processing unit 210 and a second processing unit 220.

The processor 200 may be a main CPU for overall control of a vehicle control system 10. In an embodiment, the processor 200 may execute a Bluetooth® application (BT application) to support the hands-free call mode through the user terminal and the Bluetooth® communication through communication between the Bluetooth® application and the communication device.

The first processing unit 210 may determine the relative position of the user terminal 20 with respect to the vehicle 1. In an embodiment, the relative position may include a distance between the vehicle 1 and the user terminal 20 and a direction in which the user terminal 20 is positioned with respect to the vehicle 1 and may be used as a meaning including information for determining whether the user terminal 20 is positioned inside or outside the vehicle 1 accordingly.

The first processing unit 210 may determine the relative position at regular intervals while the user terminal 20 is busy. The regular intervals may be set according to various conditions such as a communication state, a call environment, or a position of a vehicle and may be changed.

For example, the first processing unit 210 may determine the relative position using at least one of Wi-Fi, digital key BLE, and UWB methods.

The first processing unit 210 may compare positioning results using the Wi-Fi, digital key BLE, and UWB methods with a preset matching table and determine whether the user terminal 20 is positioned inside or outside the vehicle. The matching table may be record data that stores positioning results in a state in which the user terminal 20 is positioned inside the vehicle 1 and results obtained by separately experimenting the positioning results in the state in which the user terminal 20 is positioned inside the vehicle 1 according to each positioning method. The matching table may be stored in the memory 400.

For example, the first processing unit 210 may determine the relative position between the vehicle and the user terminal through at least one UWB positioning method among a time of flight (TOF) method of calculating a distance by measuring the time it takes for a signal to move from a transmitter to a receiver, a two-way ranging (TWR) method of calculating a distance by measuring the round-trip time between a transmitter and a receiver, and an angle of arrival (AOA) method of calculating a position by measuring an angle at which the signal reaches the receiver.

Alternatively, the first processing unit 210 may determine the relative position between the vehicle and the user terminal through at least one Wi-Fi positioning method among a received signal strength indicator (RSSI) method of estimating a distance by measuring the strength of a Wi-Fi signal, the TOF method of calculating a distance by measuring the time it takes for the signal to travel from a transmitter to a receiver, and a fingerprinting method of previously measuring a Wi-Fi signal strength profile (fingerprint) at a specific position to build a database and estimating a position by comparing the above profile with a currently measured signal strength.

Alternatively, the first processing unit 210 may determine the relative position between the vehicle and the user terminal through at least one Bluetooth® positioning method among the RSSI method of estimating a distance by measuring the strength of a BLE signal, the AOA method of calculating the position by measuring the angle at which the signal reaches the receiver, and the fingerprinting method of previously measuring a BLE signal strength profile (fingerprint) at a specific position to build a database and estimating a position by comparing the above profile with a currently measured signal strength.

In addition, the first processing unit 210 may determine the relative position using an open or closed state of the vehicle 1 door and the strength of the Bluetooth® signal. The first processing unit 210 may receive a door state change signal from a door sensor (not shown) mounted on the door. The door sensor may output the door state change signal including a change time point and a change state when the door state is changed from an open state to a closed state or from the closed state to the open state and transmit the door state change signal to the first processing unit 210. After receiving the door state change signal, the first processing unit 210 may determine whether a door state change duration has exceeded a preset time.

When the door state change duration exceeds the preset time, the first processing unit 210 may determine that the user terminal 20 is positioned inside the vehicle 1 when an average value of Bluetooth® signal strengths during the state change duration exceeds a preset threshold value.

Alternatively, when the door state change duration exceeds the preset time, the first processing unit 210 may determine that the user terminal 20 is positioned outside the vehicle when the average value of Bluetooth® signal strengths during the state change duration is the preset threshold value or less.

In the embodiment of the present disclosure, a call connection system may be a multimedia system for performing wireless communication with the user terminal to generate a call channel and providing a hands-free call function inside the vehicle through the generated call channel.

In the following embodiments, an example in which the call connection system is the AVNT 100 will be described, but any multimedia system for providing wireless communication, input and output functions of an audio signal may also be applied.

The second processing unit 220 may set a call channel for the user terminal 20 using the AVNT 100 of the vehicle when it is determined that the user terminal 20 is positioned inside the vehicle 1 using the relative position and set a call channel using the user terminal 20 when it is determined that the user terminal 20 is positioned outside the vehicle 1. That is, the second processing unit 220 may set a hands-free mode when it is determined that the user terminal 20 is positioned inside the vehicle 1 and set a phone call mode when it is determined that the user terminal 20 is positioned outside the vehicle 1.

The second processing unit 220 may switch the call channel from the AVNT 100 to the user terminal 20 when it is determined that the user terminal 20 is moved from the inside of the vehicle to the outside of the vehicle while the user terminal 20 is busy. The second processing unit 220 may periodically receive the relative position between the vehicle 1 and the user terminal 20 from the first processing unit 210. The second processing unit 220 may perform automatic switching of the call channel by switching the call channel from the hands-free mode to the phone call mode when it is determined that the user terminal 20 is moved from the inside of the vehicle 1 to the outside of the vehicle 1 according to the periodically received relative position. Therefore, the user may perform continuous calls even when leaving the vehicle 1 while making a call in a hands-free state.

The second processing unit 220 may switch the call channel from the user terminal 20 to the AVNT 100 when it is determined that the user terminal 20 is moved from the outside of the vehicle 1 to the inside of the vehicle 1 while the user terminal 20 is busy. The second processing unit 220 may perform automatic switching of the call channel by switching the call channel from the phone call mode to the hands-free mode when it is determined that the user terminal 20 is moved from the outside of the vehicle 1 to the inside of the vehicle 1 according to the periodically received relative position. Therefore, the user may perform continuous calls through the AVNT 100 while entering the vehicle 1 and sitting down while making a phone call.

The second processing unit 220 may set the call channel according to signals received through the AVNT 100. The second processing unit 220 may forcibly switch the call channel when received a user input through the AVNT 100.

That is, when a phone call mode setting input is received, the second processing unit 220 may forcibly switch the call channel to the user terminal 20 even when it is determined that the user terminal 20 is positioned inside the vehicle 1.

Alternatively, when a hands-free call mode setting input is received, the second processing unit 220 may forcibly switch the call channel to the AVNT 100 even when it is determined that the user terminal 20 is positioned outside the vehicle 1.

The second processing unit 220 may input and output an audio signal of content reproduced in the user terminal 20 using the set call channel. The second processing unit 220 may control the content reproduced in the user terminal 20 to be output through the set call channel in addition to the audio signal or video signal for the call.

For example, in a state of the hands-free call mode, the second processing unit 220 may control at least one of the video signal and the audio signal of the content reproduced in the user terminal 20 to be output through the AVNT 100.

Alternatively, in a state of the phone call mode, the second processing unit 220 may control at least one of the video signal and the audio signal of the content reproduced in the user terminal 20 to be output through the user terminal 20.

The second processing unit 220 may additionally use at least one of a sit-down detection signal of a seat sensor (not shown) and a belt fastening signal of a seat belt sensor (not shown) to determine whether the user terminal 20 is positioned inside or outside the vehicle 1.

For example, when it is determined that the position of the user terminal 20 is inside the vehicle through the result of positioning, the second processing unit 220 may finally determine that the user terminal 20 is positioned inside the vehicle when the seat sensor detects the user's seat.

Alternatively, when it is determined that the position of the user terminal 20 is inside the vehicle 1 through the result of positioning, the second processing unit 220 may finally determine that the user terminal 20 is positioned inside the vehicle when the seat belt sensor detects the user's belt fastening

That is, even when it is determined that the user terminal 20 is positioned inside the vehicle 1 through the result of positioning, the second processing unit 220 may finally determine the relative position of the user terminal 20 additionally using at least one of the sit-down detection signal and the belt fastening signal, thereby increasing the accuracy of position determination.

The second processing unit 220 may display the currently set call channel using the AVNT 100. The second processing unit 220 may control the state of the hands-free call mode or the phone call mode to be displayed according to the current call channel and display the switched channel state in real time when the call channel is switched.

The memory 400 may store an application and various pieces of data for controlling the vehicle 1 and load the application or read or write the data at the request of the processor 200.

The memory 400 may store at least one algorithm that performs calculation or execution of various commands for the operation of the vehicle control system 10 according to the embodiment. The memory 400 may include at least one storage medium of a flash memory, a hard disc, a memory card, a ROM, a RAM, an EEPROM, a PROM, a magnetic memory, a magnetic disc, and an optical disc.

For convenience, one or more figures are described by way of an example in which the steps are performed by a processor circuit. One, some, or all steps of the example method of a figure, or portions thereof, may be performed by one or more other circuits. One or some, steps of the example method of a figure may be omitted, performed in other orders, and/or otherwise modified, and/or one or more additional steps may be added.

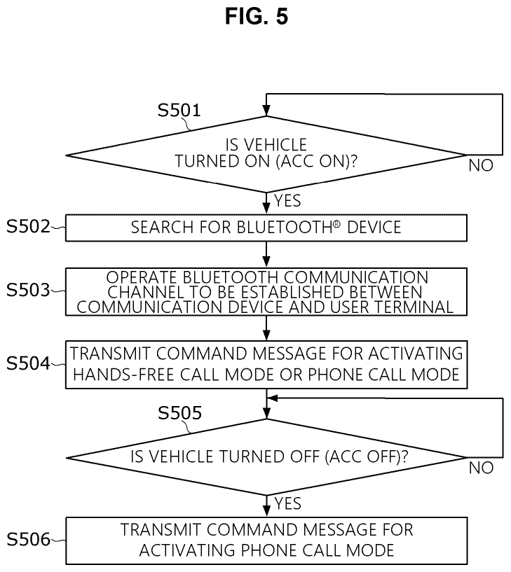

FIG. 5 is a view for describing the operation of a vehicle control system according to the embodiment. Referring to FIG. 5, when a turn-on (ACC on) of a vehicle is identified, a processor may execute a Bluetooth® application to perform an operation for searching for a Bluetooth® device positioned near a vehicle. Since the processor may provide information on turn-on (ACC on)/turn-off (ACC off) of a vehicle to the AVNT, the AVNT may check the ignition state of the vehicle. Here, the processor and the AVNT are communicatively available by being connected to a CAN, and the processor may transmit vehicle turn-on/off information to the AVNT through CAN communication (S501 and S502).

When found a user terminal by searching for a Bluetooth® device, the processor may operate to establish a Bluetooth® communication channel between a communication device and the user terminal. When the Bluetooth® communication channel is established between the communication device and the user terminal, the processor transmits a command message for activating a hands-free call mode or a phone call mode to the user terminal through the communication device. Alternatively, when a user command through a user interface of the AVNT is present, the processor may transmit the command message for activating the hands-free call mode or the phone call mode to the user terminal through the communication device. In addition, the user terminal receiving the command message for activating the hands-free call mode or the phone call mode activates the call mode according to the command message (S503 to S505).

When the turn-off (ACC off) of the vehicle is identified after the vehicle is turned on, the processor transmits the command message for activating the phone call mode to the user terminal through the communication device. That is, the processor may forcibly switch the hands-free call mode of the user terminal to the phone call mode when the vehicle is turned off (S506).

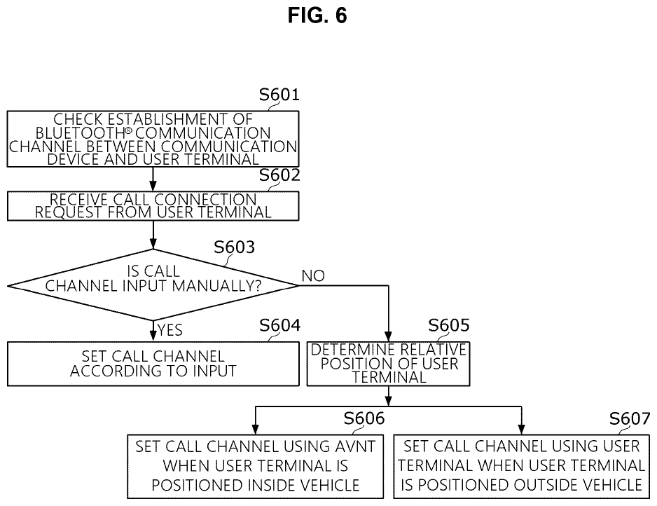

FIG. 6 is a view for describing the operation of a vehicle control system according to another embodiment. Referring to FIG. 6, a processor checks whether a Bluetooth® communication channel is established between a communication device and a user terminal (S601).

When receiving a call connection request from the user terminal while the Bluetooth® communication channel is established between the communication device and the user terminal, the processor determines whether the call channel is manually input through an AVNT (S602 and S603).

When the call channel is manually input, the processor sets a call channel of the user terminal according to the input (S604).

When the call channel is not manually input, the processor determines a relative position of the user terminal with respect to a vehicle to determine whether the user terminal is positioned inside or outside the vehicle (S605).

The processor sets the call channel of the user terminal using the AVNT when the user terminal is positioned inside the vehicle (S606).

Alternatively, the processor sets the call channel using the user terminal when the user terminal is positioned outside the vehicle (S607).

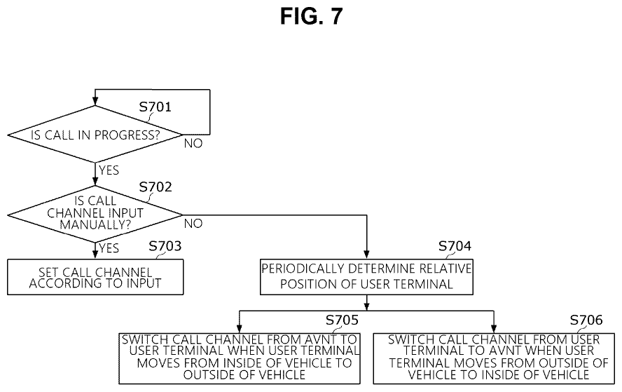

FIG. 7 is a view for describing the operation of a vehicle control system according to still another embodiment. Referring to FIG. 7, when a call is in progress while a Bluetooth® communication channel is established between a communication device and a user terminal, a processor determines whether a call channel is manually input through an AVNT (S701 and S702).

When the call channel is manually input, the processor sets a call channel of the user terminal according to the input (S703).

When the call channel is not manually input, the processor periodically determines a relative position of the user terminal to determine whether the user terminal is positioned inside or outside a vehicle (S704).

When it is determined that the user terminal is moved from the inside of the vehicle to the outside of the vehicle, the processor switches the call channel from the AVNT to the user terminal (S705).

Alternatively, when it is determined that the user terminal is moved from the outside of the vehicle to the inside of the vehicle, the processor switches the call channel from the user terminal to the AVNT (S706).

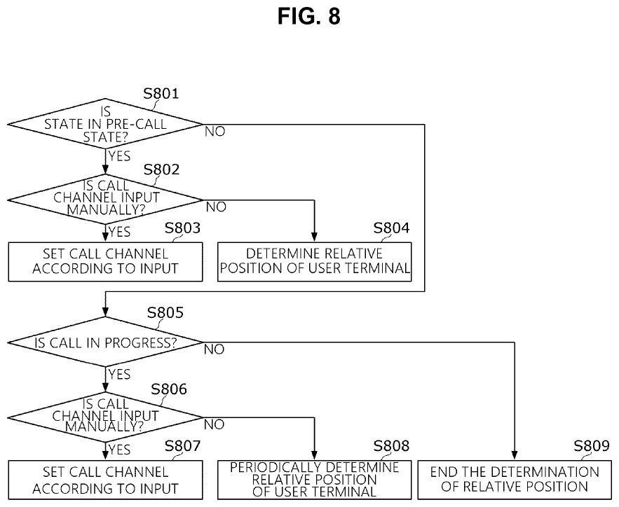

FIG. 8 is a view for describing the operation of a vehicle control system according to yet another embodiment. Referring to FIG. 8, a processor checks a call progress state while a Bluetooth® communication channel is established between a communication device and a user terminal (S801).

The processor determines whether the call channel is manually input via an AVNT in a pre-call state (S802).

When the call channel is manually input, the processor sets a call channel of the user terminal according to the input (S803).

When the call channel is not manually input, the processor determines a relative position of the user terminal with respect to a vehicle (S804).

While the call is in progress, the processor determines whether the call channel is manually input through the AVNT (S805 and S806).

When the call channel is manually input, the processor sets a call channel of the user terminal according to an input (S807).

When the call channel is not manually input, the processor periodically determines the relative position of the user terminal (S808).

When the call ends, the processor ends the process of determining the relative position (S809).

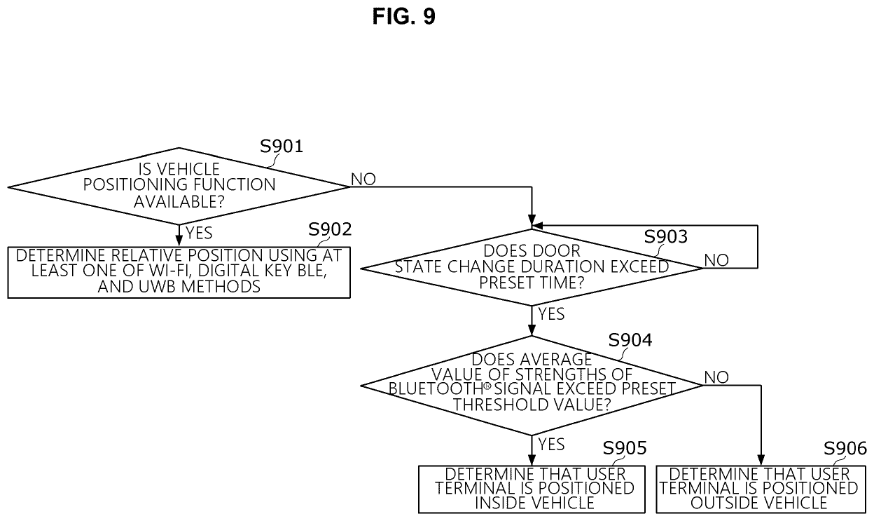

FIG. 9 is a view for describing the operation of a vehicle control system according to yet another embodiment. Referring to FIG. 9, when using a positioning function of a vehicle, a processor determines a relative position using at least one of Wi-Fi, digital key BLE, and UWB methods (S901 and S902).

The processor compares positioning results using the Wi-Fi, digital key BLE, and UWB methods with a preset matching table and determines the relative position depending on whether the user terminal is positioned inside or outside the vehicle.

When the process cannot use the positioning function of the vehicle, the processor determines whether a door state change duration received from a door sensor mounted on a door exceeds a preset time (S903).

When the door state change duration exceeds the preset time, the processor determines that the user terminal is positioned inside the vehicle when an average value of the strengths of a Bluetooth® signal during the state change duration exceeds a preset threshold value (S904 and S905).

Alternatively, when the door state change duration exceeds the preset time, the processor determines that the user terminal is positioned outside the vehicle when the average value of the strengths of the Bluetooth® signal during the state change duration is the preset threshold value or less (S906).

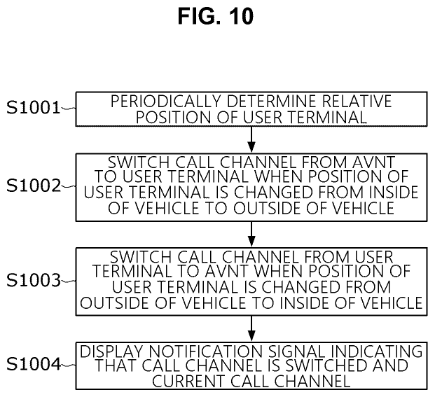

FIG. 10 is a view for describing the operation of a vehicle control system according to yet another embodiment. Referring to FIG. 10, a processor periodically determines a relative position of a user terminal to determine whether the user terminal is positioned inside or outside a vehicle (S1001).

When a position of the user terminal is changed from the inside to outside of the vehicle, the processor switches a call channel from an AVNT to the user terminal (S1002).

Alternatively, when the position of the user terminal is changed from the outside to inside of the vehicle, the processor switches the call channel from the user terminal to the AVNT (S1003).

When the call channel is switched, the processor displays a currently set call channel together with a notification signal indicating that the call channel is switched using the AVNT (S1004).

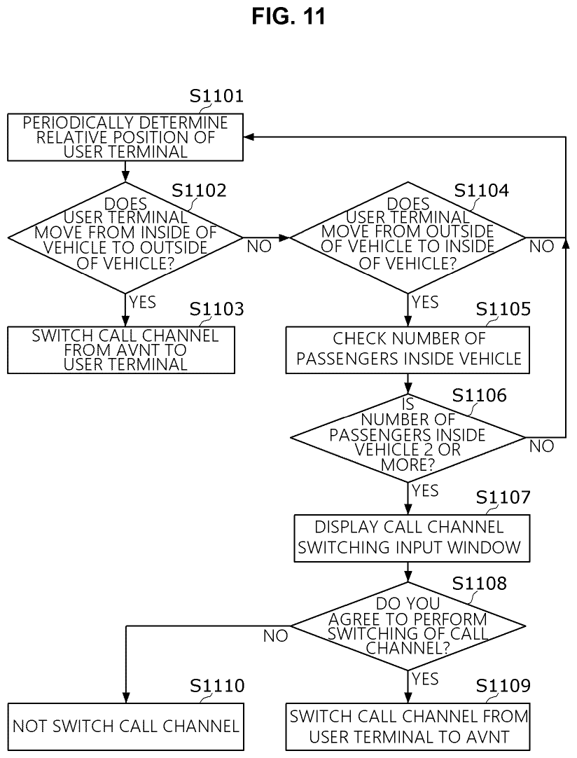

FIG. 11 is a view for describing the operation of a vehicle control system according to yet another embodiment. Referring to FIG. 11, while a call is in progress while a Bluetooth® communication channel is established between a communication device and a user terminal, a processor periodically determines a relative position of the user terminal to determine whether the user terminal is positioned inside or outside a vehicle (S1101).

When it is determined that the user terminal is moved from the inside of the vehicle to the outside of the vehicle, the processor switches a call channel from an AVNT to the user terminal (S1102 and S1103).

Alternatively, when it is determined that the user terminal is moved from the inside of the vehicle to the outside of the vehicle, the processor checks the number of passengers inside the vehicle. For example, the processor checks the number of passengers inside the vehicle using a sit-down detection signal of a seat sensor and a belt fastening signal of a seat belt sensor (S1104 and S1105).

When the number of passengers inside the vehicle is 2 or more, the processor displays an input window that allows a user to select whether to perform switching of a call channel through the AVNT. That is, even when the user terminal is moved to the inside of the vehicle, the processor does not immediately switch the call channel right away when other passengers are present inside the vehicle and allows the user to select whether to perform switching of the channel (S1106 and S1107).

When receiving an input agreeing to perform switching of the call channel through AVNT, the processor switches the call channel from the user terminal to the AVNT (S1108 and S1109).

Alternatively, the processor controls the call to be performed through the user terminal without performing switching of the call channel when receiving an input that does not agree to perform the switching of the call channel through the AVNT or when not receiving any input (S1110).

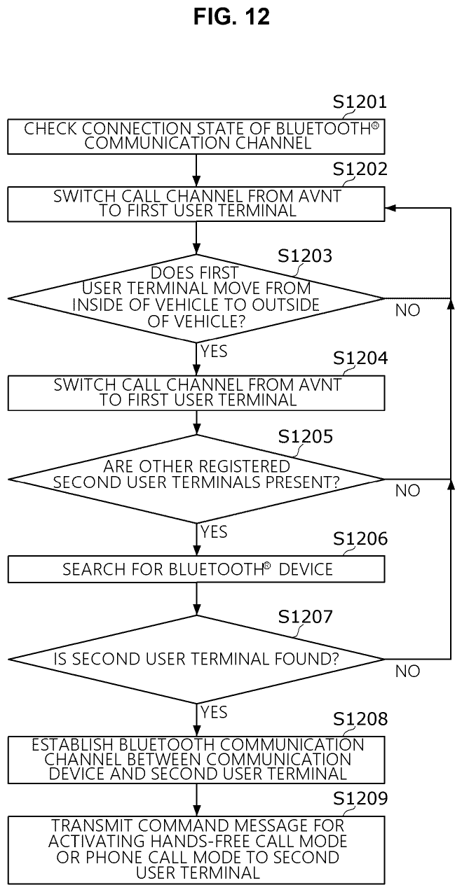

FIG. 12 is a view for describing the operation of a vehicle control system according to yet another embodiment. Referring to FIG. 12, a state in which a Bluetooth® communication channel is established between a communication device and a first user terminal is checked (S1201).

A processor periodically determines a relative position of the first user terminal to determine whether the user terminal is positioned inside or outside a vehicle (S1202).

When it is determined that the first user terminal is moved from the inside of the vehicle to the outside of the vehicle, the processor switches a call channel from an AVNT to the first user terminal (S1203 and S1204).

The processor determines whether a registered second user terminal other than the first user terminal moving from the inside of the vehicle to the outside of the vehicle is present (S1205).

When the registered second user terminal is present, the processor performs an operation for searching for a Bluetooth® device (S1206).

When found a second user terminal by searching for a Bluetooth® device, the processor operates to establish a Bluetooth® communication channel between the communication device and the second user terminal (S1207 and S1208).

When the Bluetooth® communication channel is established between the communication device and the user terminal, the processor transmits a command message for activating a hands-free call mode or a phone call mode to the second user terminal through the communication device (S1209).

The term “unit” used in the present embodiment means a software or hardware component such as a field-programmable gate array (FPGA) or an ASIC, and the “unit” performs certain roles. However, the “unit” is not limited to software or hardware. The “unit” may be disposed in an addressable storage medium and configured to reproduce one or more processors. Therefore, as an example, the “unit” includes components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

According to the vehicle control system and method according to embodiments, it is possible to automatically set input and output devices for performing calls depending on a position of a mobile device.

In addition, it is possible to perform automatic switching of the input and output devices for performing calls by detecting a change in position in real time when making a call while moving.

Therefore, it is possible to increase convenience of a user when making a call and increase satisfaction.

In addition, it is possible to perform automatic switching of a device for outputting content reproduced in a portable phone.

Although the present disclosure has been described above with reference to exemplary embodiments, those skilled in the art will understand that the present disclosure may be modified and changed variously without departing from the spirit and scope of the present disclosure as described in the appended claims.

1. A vehicle control system comprising:
a communication device configured to perform pairing between a user terminal and a vehicle using a Bluetooth® signal to perform transmission and reception of an audio signal;
a first processing unit configured to determine a relative position of the user terminal with respect to the vehicle; and
a second processing unit configured to set a call channel of the user terminal using a call connection system of the vehicle when it is determined that the user terminal is positioned inside the vehicle using the relative position, and to set the call channel using the user terminal when it is determined that the user terminal is positioned outside the vehicle.

2. The vehicle control system of claim 1, wherein the first processing unit is configured to determine the relative position at regular intervals while the user terminal is busy.

3. The vehicle control system of claim 2, wherein, when it is determined that the user terminal is moved from the inside of the vehicle to the outside of the vehicle while the user terminal is busy, the second processing unit is configured to switch the call channel from the call connection system to the user terminal.

4. The vehicle control system of claim 2, wherein, when it is determined that the user terminal is moved from the outside of the vehicle to the inside of the vehicle while the user terminal is busy, the second processing unit is configured to switch the call channel from the user terminal to the call connection system.

5. The vehicle control system of claim 1, wherein the second processing unit is configured to set the call channel according to a signal received through the call connection system.

6. The vehicle control system of claim 1, wherein the second processing unit is configured to receive and output an audio signal of content reproduced in the user terminal using the set call channel.

7. The vehicle control system of claim 1, wherein the first processing unit is configured to determine the relative position using a positioning result through at least one of Wi-Fi, digital key Bluetooth® low energy (BLE), and ultra-wideband (UWB) methods.

8. The vehicle control system of claim 1, wherein the first processing unit is configured to determine the relative position using an opening or closing state of a door of the vehicle and a strength of the Bluetooth® signal.

9. The vehicle control system of claim 7, wherein the second processing unit is configured to determine whether the user terminal is positioned inside or outside the vehicle using the positioning result, a sit-down detection signal of a seat sensor, and a belt fastening signal of a seat belt sensor.

10. The vehicle control system of claim 1, wherein the second processing unit is configured to display a currently set call channel using the call connection system.

11. A vehicle control method comprising:
performing, by a communication device, pairing between a user terminal and a vehicle using a Bluetooth® signal;
determining, by a processor, a relative position of the user terminal with respect to the vehicle; and
setting, by the processor, a call channel of the user terminal using a call connection system of the vehicle when it is determined that the user terminal is positioned inside the vehicle using the relative position, and setting the call channel using the user terminal when it is determined that the user terminal is positioned outside the vehicle.

12. The vehicle control method of claim 11, wherein determining the relative position includes:
determining a call state of the user terminal; and
determining the relative position at regular intervals while the user terminal is busy.

13. The vehicle control method of claim 12, wherein setting the call channel includes switching the call channel from the call connection system to the user terminal when it is determined that the user terminal is moved from the inside of the vehicle to the outside of the vehicle while the user terminal is busy.

14. The vehicle control method of claim 12, wherein setting the call channel includes switching the call channel from the user terminal to the call connection system when it is determined that the user terminal is moved from the outside of the vehicle to the inside of the vehicle while the user terminal is busy.

15. The vehicle control method of claim 11, further comprising setting, by the processor, the call channel according to a signal received through the call connection system.

16. The vehicle control method of claim 15, further comprising stopping, by the processor, an operation of determining the relative position.

17. The vehicle control method of claim 11, further comprising receiving and outputting, by the processor, an audio signal of content reproduced in the user terminal using the set call channel.

18. The vehicle control method of claim 11, further comprising determining, by the processor, the relative position using an opening or closing state of a door of the vehicle and a strength of the Bluetooth® signal.

19. The vehicle control method of claim 11, wherein determining the relative position includes:
performing positioning through at least one of Wi-Fi, digital key Bluetooth® low energy (BLE), and ultra-wideband (UWB) methods; and
determining whether the user terminal is positioned inside or outside the vehicle using a positioning result, a sit-down detection signal of a seat sensor, and a belt fastening signal of a seat belt sensor.

20. The vehicle control method of claim 11, further comprising displaying, by the processor, a currently set call channel using the call connection system.
